(19) United States
(12) Patent Application Publication
(10) Pub. No.: US 2006/0026121 A1
(43) Pub. Date: Feb. 2, 2006

(54) Data processing method and printing system

(75) Inventor: Yoshihide Terao, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/187,807

(22) Filed: Jul. 25, 2005

(30) Foreign Application Priority Data
Jul. 28, 2004 (JP) 2004-220684

(51) Int. Cl. G06F 17/30

(52) U.S. Cl. 707/1

(57) ABSTRACT

There is disclosed a printing system which can limit users who access a hot folder as a common folder, and need not prepare for another server only for user management. In a printing system of this invention, a management server monitors digital data stored in the hot folder, and limits users who can access the hot folder. When the management server detects that print data is input to the hot folder, a user verification dialog is displayed on a computer as a print data input source to make user verification. When the user verification has succeeded, the digital data input to the hot folder is printed using a printer; when the user verification has failed, the print process of the digital data input to the hot folder using the printer is canceled, thereby limiting the user who accesses the hot folder.

### FIELD OF THE INVENTION

The present invention relates to a printing system which prints digital data stored in a so-called hot folder, using an image processing apparatus in accordance with the print setting of the hot folder.

### BACKGROUND OF THE INVENTION

Conventionally, a hot folder is used as a method of easily printing digital data created on a PC according to a predetermined print setting.

For example, in one prior art, a hot folder to control print outputs of prints is used. More specifically, a plurality of hot folders are created on a server, and sub-monitoring programs are launched in correspondence with these hot folders to monitor them at predetermined time intervals. When document data is input to each hot folder, a rule set for that hot folder in advance is checked, and the input data is automatically registered as a job.

Using such hot folder, the user can easily print digital data by inputting (dragging & dropping) it into the hot holder without any troublesome print setting.

However, in the aforementioned prior art, each hot folder does not undergo any user management, and everyone can use the hot folder. Hence, a security problem is posed.

Likewise, since the hot folder does not undergo any user management, no limitation is imposed to allow only a specific user to make an advanced print process (color print process or the like).

Furthermore, since the hot folder does not undergo any user management, the administrator side cannot acquire any information about which user used the hot folder.

### SUMMARY OF THE INVENTION

The present invention has been made in consideration of the aforementioned problems, and provides a printing system which can limit users who access a hot folder as a predetermined folder, and need not prepare for an independent server for the purpose of only user management.

The present invention provides a printing system which requires only one management server to facilitate management, and can improve the user's operability and security level.

Furthermore, the present invention provides a printing system which allows an administrator to easily browse a log of users who used a hot folder using a Web browser, can limit users who access the hot folder, and can limit the available functions of the hot folder for respective users.

Moreover, the present invention provides a printing system which can limit users who can access a hot folder only on a local PC without any server.

According to one aspect of the present invention, preferably, a data processing method suited to a printing system which has a management unit that monitors a predetermined folder to which digital data is input via a computer, and controls a printer to execute a print process of the digital data input to the predetermined folder, comprises steps of:

making, when the digital data is input to the predetermined folder, the computer as an input source of the digital data display a user verification dialog; and

controlling a print process of the digital data input to the predetermined folder by the printer on the basis of a result of a user verification process executed via the user verification dialog.

According to another aspect of the present invention, preferably, the predetermined folder includes a common folder on the network, and

the method further comprises steps of:

making, when the digital data is input to the common folder, the computer as an input source of the digital data display a user verification dialog; and

permitting a print process of the digital data input to the common folder by the printer on the basis of a result of a user verification process executed via the user verification dialog.

According to another and further aspect of the present invention, preferably, the predetermined folder includes a predetermined folder on a local computer, and

the method further comprises steps of:

making, when the digital data is input to the predetermined folder, the local computer display a user verification dialog; and

permitting a print process of the digital data input to the predetermined folder by the printer on the basis of a result of a user verification process executed via the user verification dialog.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a diagram showing the overall arrangement of the first embodiment;

FIG. 2 is a flowchart for explaining the operation of the first embodiment;

FIG. 3 shows a first practical example of a user verification dialog;

FIG. 4 shows a second practical example of a user verification dialog;

FIG. 5 shows a first practical example of a user access history display window using a Web browser;

FIG. 6 shows a second practical example of a user access history display window using a Web browser;

FIG. 7 shows a third practical example of a user access history display window using a Web browser;

FIG. 8 is a view illustrating a digital data input operation from a user PC into a hot folder;

FIG. 9 shows a hot folder operation window of the first embodiment;

FIG. 10 shows a user management setting window of the first embodiment;

FIG. 11 is a diagram showing the overall arrangement of the second embodiment;

FIG. 12 is a flowchart for explaining the operation of the second embodiment;

FIG. 13 shows a hot folder operation window of the second embodiment;

FIG. 14 shows a first practical example of a user management setting window of the second embodiment;

FIG. 15 shows a second practical example of a user management setting window of the second embodiment;

FIG. 16 shows a third practical example of a user management setting window of the second embodiment;

FIG. 17 is a diagram showing the overall arrangement of the third embodiment;

FIG. 18 is a flowchart for explaining the operation of the third embodiment;

FIG. 19 is a flowchart for explaining the operation of the fourth embodiment;

FIG. 20 shows a confirmation dialog of a conformer; and

FIG. 21 is a view showing a window displayed when the user selects a conformer.

### DETAILED DESCRIPTION OF THE PREFERRED EMBODIMENTS

Preferred embodiments of the present invention will be described in detail hereinafter with reference to the accompanying drawings.

### First Embodiment

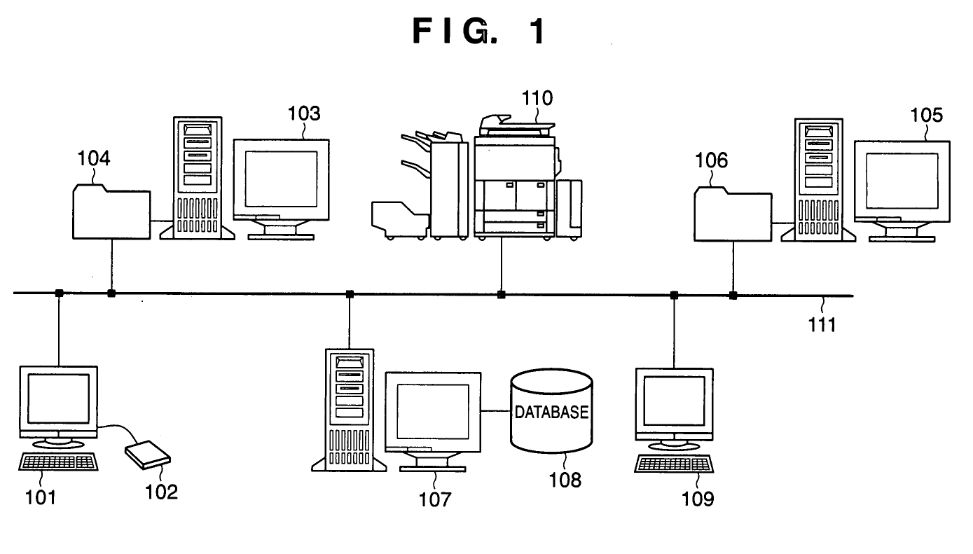

FIG. 1 shows the overall arrangement of the first embodiment, and devices shown in FIG. 1 are connected via a network 111.

Reference numeral 101 denotes a PC on which the user makes operations. The user stores (drags & drops) digital data (job data, application data, etc.) created on this PC in an arbitrary hot folder 104 or 106 disclosed on the network 111. Then, a management information system server (to be referred to as MIS server hereinafter) 107 which has a function of managing a printer, expendables, and the like executes a user verification procedure (to be described later). If the user is verified, a print process can be applied to the digital data stored in the hot folder, using a printer 110 connected onto the network 111.

Note that the hot folders 104 and 106 on the network 111 are shared on the network 111 using computers 103 and 105. The MIS server 107 also serves as a management information server that limits users who can use the hot folders 104 and 106. The MIS server 107 can constantly monitor digital data input to the hot folders 104 and 106, and can save an access log in a database 108.

In this embodiment, a hot folder is a folder in common to users, and is connected on the network. When a predetermined job or data is stored in that folder, a predetermined process is automatically executed.

Reference numeral 109 denotes an administrator PC. The administrator PC 109 is used to acquire the access log of users who accessed the hot folders 104 and 106 from the database 108, and to browse the log on a Web browser.

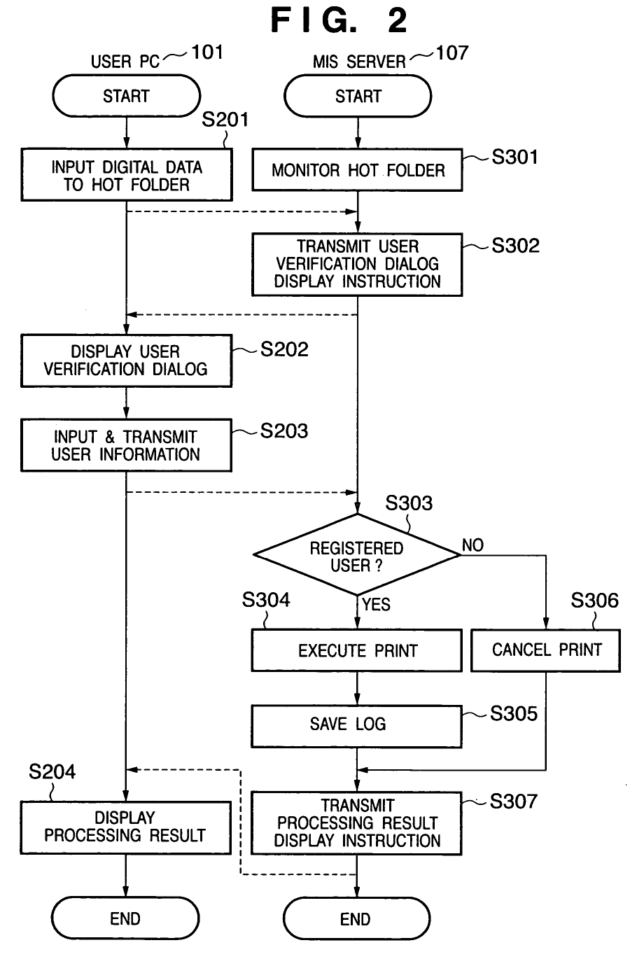

FIG. 2 is a flowchart for explaining the operation of the first embodiment. Referring to FIG. 2, steps S201 to S204 correspond to operations on the user PC 101 side when digital data is input from the user PC 101 to the hot folder 104 or 106, and steps S301 to S307 correspond to operations on the MIS server 107 when digital data is input to the hot folder 104 or 106.

Referring to FIG. 2, in step S201, the user inputs digital data created on the PC 101 into an arbitrary hot folder 104 or 106 by dragging & dropping.

The MIS server 107 constantly monitors the hot folders 104 and 106 in step S301. If it is detected that digital data is input to the hot folder 104 or 106, the MIS server 107 instructs the user PC to display a user verification dialog in step S302. That is, if the MIS server 107 detects that digital data is input to the hot folder 104 or 106, it acquires information about where (from which PC) the data is input (e.g., the IP address of the PC, etc.) from the computer 103 or 105, and sends an instruction to the corresponding user PC to display a verification dialog.

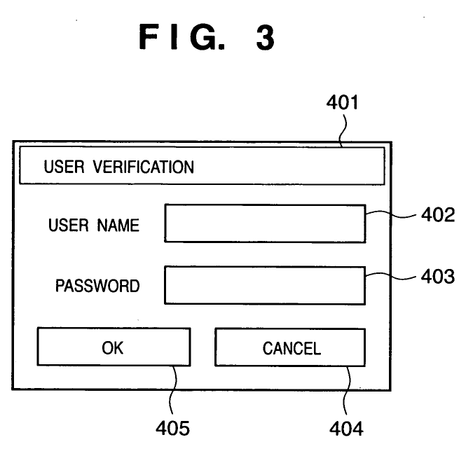

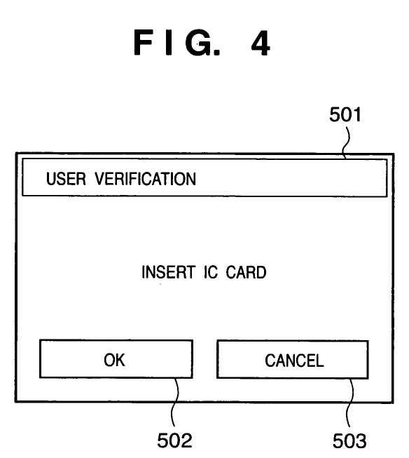

In response to this instruction, on the user PC side, a user verification dialog shown in FIGS. 3 or 4 is displayed on the display screen of the PC 101 in step S202. FIG. 3 shows a verification dialog of a type which prompts the user to directly input the user name and password, and FIG. 4 shows a verification dialog of a type which prompts the user to insert an IC card that stores the user name and password. The display operation of this verification dialog is implemented as follows.

In step S203, the user inputs the user name and password, which are transmitted to the MIS server 107.

The MIS server 107 receives that user data, and checks in step S303 if the received user data is equal to that registered in a user management database. If the two user data are equal to each other, the flow advances to step S304; otherwise, the flow advances to step S306.

In step S306, the MIS server 107 determines that the digital data is input by an invalid user, and controls the printer 110 not to execute any print process. Also, the MIS server 107 deletes the digital data input to the hot folder.

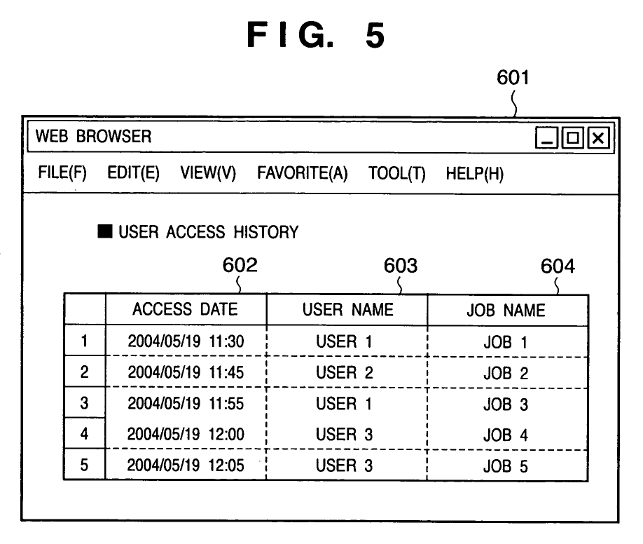

On the other hand, in step S304 the MIS server 107 determines that the data is input by a valid user who has been successfully verified, and controls the printer 110 to execute a print process. The flow then advances to step S305 to save an access date 602 to the hot folder, user name 603, and job name 604 of the user in the database 108, as shown in FIG. 5 (display example 1 of a user log on a Web browser), and to allow to browse that log using the Web browser on the PC 109.

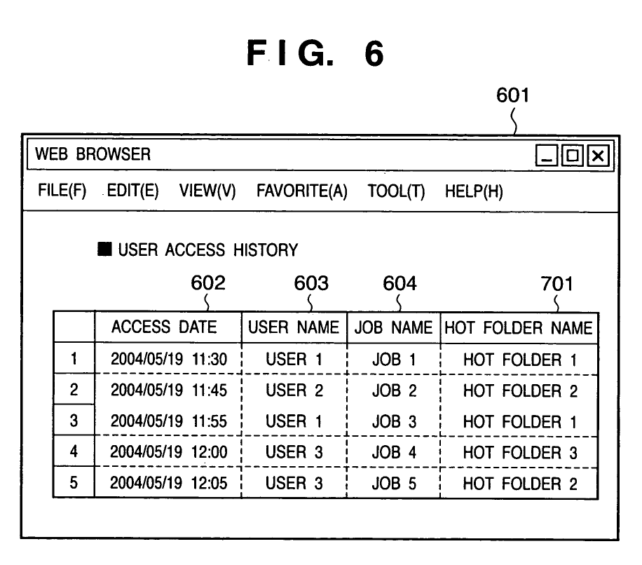

Since the MIS server can monitor a plurality of hot folders at the same time, information indicating correspondence between users and hot folders used can be saved as a hot folder name 701, as shown in FIG. 6 (display example 2 of a user log on a Web browser).

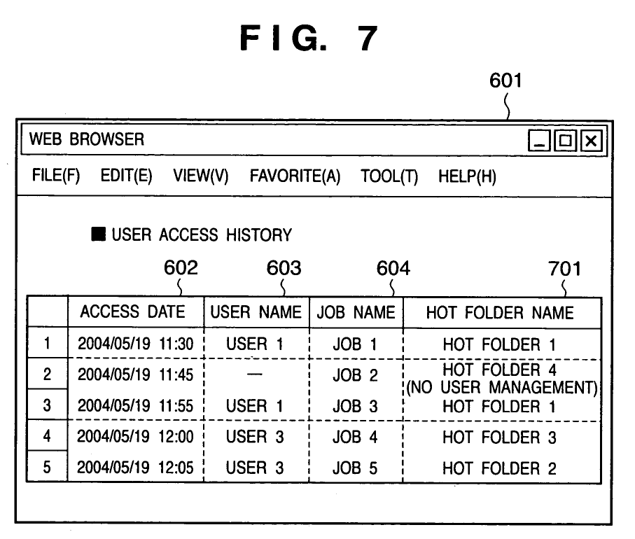

Since hot folders include those which undergo user management, and those which do not undergo user management, when an access log of hot folders which do not undergo user management is recorded, a user name column 603 is left blank, and the hot folder name is stored in a hot folder name field 701 so that the hot folder that does not undergo user management is recognized at a glance, as shown in FIG. 7 (display example 3 of a user log on a Web browser).

Finally, in step S307 the MIS server 107 transmits an instruction to the PC 101 so as to display the processing result on the PC 101. The PC 101 displays the processing result on its display screen in step S204.

Note that FIG. 2 has exemplified the print process. However, this embodiment is not limited to such specific process, and may be applied to any other processes such as a mail sending process, PDF-conversion process, special image process, and the like. A plurality of hot folders may be prepared, and different processes may be assigned to respective folders.

In the processing of the flowchart of FIG. 2, the processing result is displayed. Alternatively, the user verification result may be displayed on the display screen.

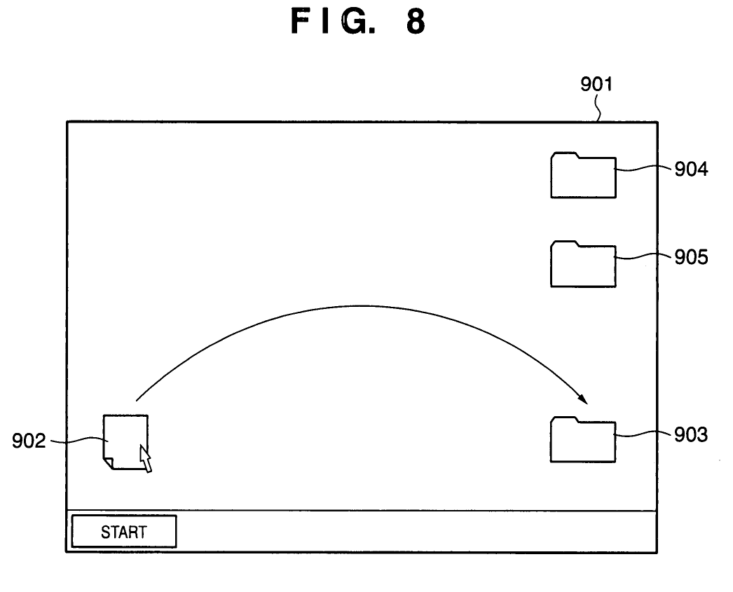

FIG. 8 shows a desktop 901 on the user PC 101, i.e., a display example of the hot folders 104 and 106 on the network 111, which is displayed on the PC 101.

The user drags & drops created digital data 902 into an arbitrary one of hot folders 904, 905, and 906, thus printing the digital data using the printer 110.

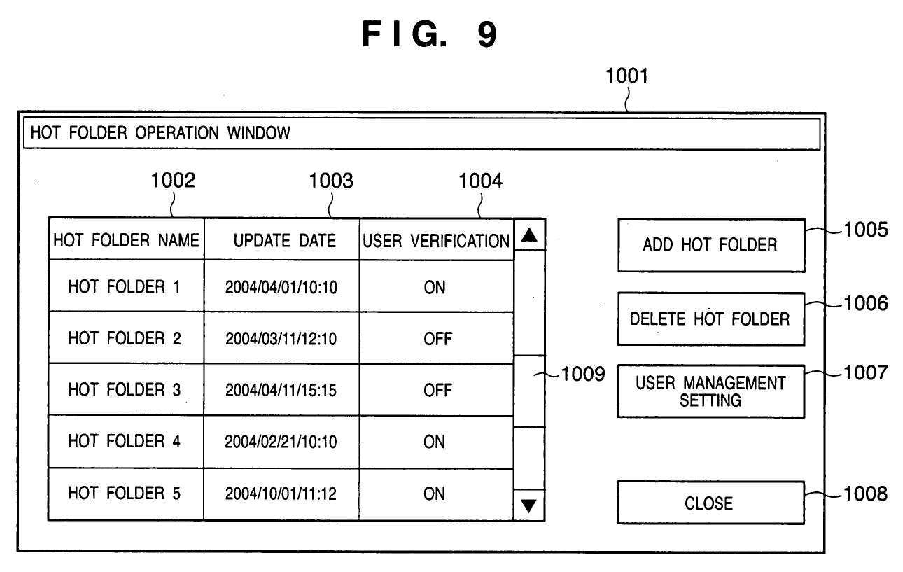

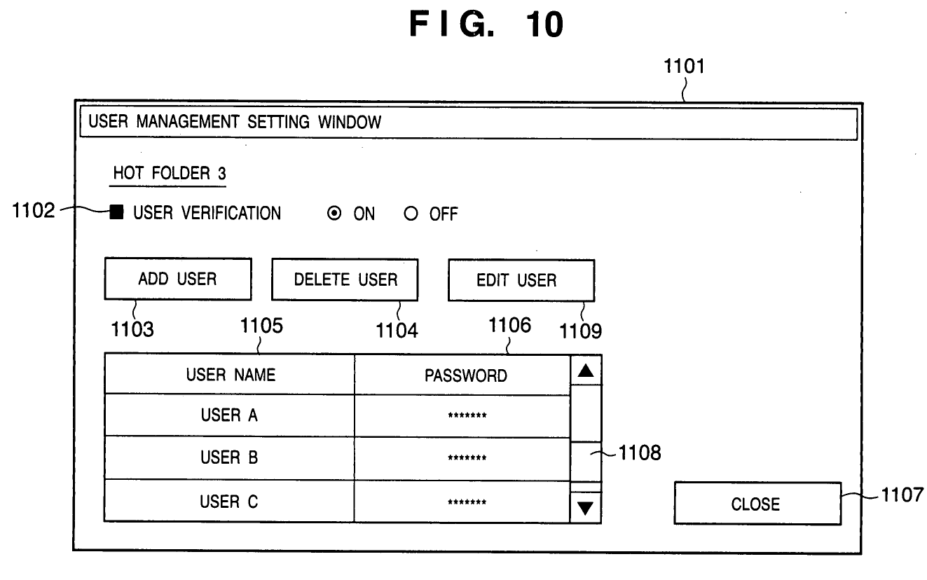

A user management method for making user verification for the hot folders will be described below using FIGS. 9 and 10.

FIGS. 9 and 10 show a display example of operation windows used to register users who can access the hot folders.

On the MIS server 107 side, a hot folder operation window 1001 shown in FIG. 9 is opened. This window displays a hot folder name field 1002 of all hot folders connected to the MIS server 107, an update date field 1003 indicating the update dates of these hot holders, and a user verification field 1004 which indicates whether a user verification setting of a hot folder of interest is ON/OFF.

This window further includes a hot folder add button 1005 and hot folder delete button 1006, which are used to add/delete a hot folder.

Furthermore, when a button 1007 used to set user verification for the selected hot folder is pressed, a user who can access that hot folder can be added/deleted.

Upon depression of the user management setting button 1007, a user management setting window 1101 shown in FIG. 10 is displayed. This window includes “ON/OFF” check buttons 1102 of user verification of the selected hot folder. When the “ON” check button is checked, user verification is required when the user accesses that hot folder.

Furthermore, the user management setting window 1101 displays a user add button 1103, user delete button 1104, and user edit button 1109. When one of these buttons is pressed, a user who can access the hot folder can be added/deleted, or the user name and password can be edited.

As described above, according to this embodiment, the MIS server 107 can limit users who can access hot folders disclosed on the network 111, thus improving the security of print processes using the hot folders.

Since the MIS server records a history of users who used the hot folders as a log, which can be browsed using a Web browser, the operation states of users who use the hot folders can be recognized.

### Second Embodiment

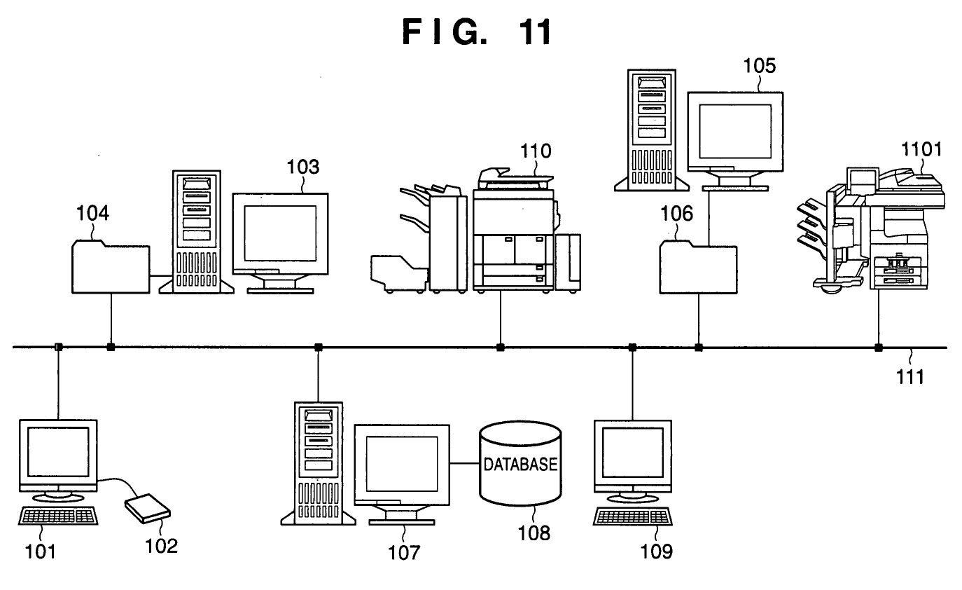

FIG. 11 shows the overall arrangement according to the second embodiment. The same reference numerals denote common parts to those in FIG. 1.

Reference numeral 101 denotes a PC on which the user makes operations. The user stores (drags & drops) digital data (application data, etc.) created on this PC in an arbitrary hot folder 104 or 106 disclosed on a network 111, thus controlling a monochrome printer 110 or color printer 1101 connected to the hot folders to execute a print process. Note that the hot folders 104 and 106 on the network 111 are shared on the network 111 using computers 103 and 105.

A management information system server (to be referred to as MIS server hereinafter) 107 serves as a management information system server that limits users who can access the hot folders 104 and 106, and can limit available print functions for respective users. The MIS server 107 can constantly monitor digital data input to the hot folders 104 and 106, and can save an access log in a database 108.

Reference numeral 109 denotes an administrator PC. The administrator PC 109 is used to acquire the access log of users who accessed the hot folders 104 and 106 from the database 108, and to browse the log on a Web browser.

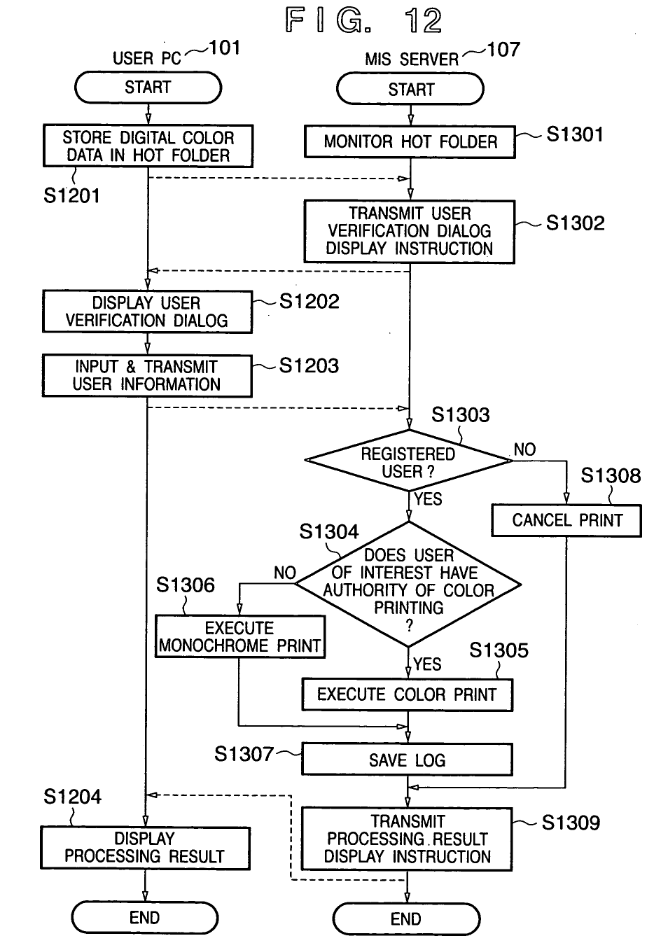

The operation according to this embodiment will be described below using FIG. 12. This embodiment is directed to processing executed when digital color data is input to a hot folder. In FIG. 12, steps S1201 to S1204 correspond to operations on the user PC 101 side when digital data is input from the user PC 101 to the hot folder 104 or 106, and steps S1301 to S1309 correspond to operations on the MIS server 107 side when digital data is input to the hot folder 104 or 106.

Referring to FIG. 12, in step S1201, the user inputs digital color data created on the PC 101 into the hot folder 104 or 106 by dragging & dropping.

The MIS server 107 constantly monitors the hot folders 104 and 106, and detects input of the digital color data as in the first embodiment.

In step S1302, the MIS server 107 instructs the user PC to display a user verification dialog. That is, if the MIS server 107 detects that digital data is input to the hot folder 104 or 106, it acquires information about where (from which PC) the data is input (e.g., the IP address of the user PC, etc.) from the computer 103 or 105, and sends an instruction to the corresponding user PC to display a verification dialog.

In response to this instruction, on the user PC side, a user verification dialog shown in FIGS. 3 or 4 is displayed on the display screen of the PC 101 in step S1202. FIG. 3 shows a verification dialog of a type which prompts the user to directly input the user name and password, and FIG. 4 shows a verification dialog of a type which prompts the user to insert an IC card that stores the user name and password. The display operation of this verification dialog is implemented as follows.

In step S1203, the user inputs the user name and password, and then presses an OK button, thus transmitting them to the MIS server 107.

The MIS server 107 receives that user data, and checks in step S1303 if the received user data is equal to that registered in a user management database. If the two user data are equal to each other, the flow advances to step S1304; otherwise, the flow advances to step S1308.

In step S1308, the MIS server 107 determines that the digital data is input by an invalid user, and controls the printer 110 not to execute any print process. Also, the MIS server 107 deletes the digital data input to the hot folder.

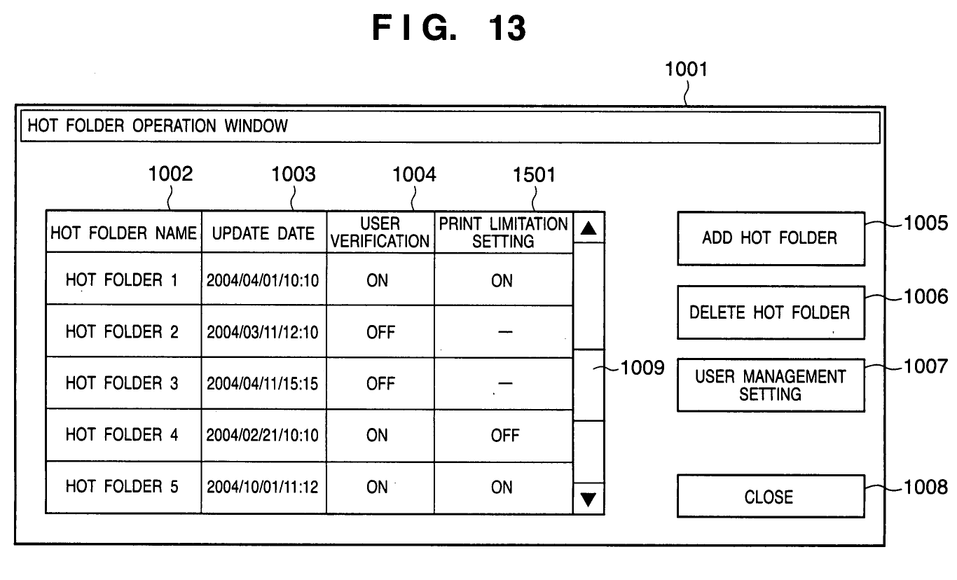

If the user has been successfully verified in step S1303, the MIS server 107 further acquires print limitations set to the hot folder to which the user input the data in correspondence with the user who input the digital data to the hot holder. The MIS server 107 checks in step S1304 if it is set to allow the user to execute, using the hot folder 104 or 106, a color print process of the digital color data input to the hot folder 104 or 106. That is, it is determined whether or not the user has the authority of color printing via the hot folder. Note that a method of setting print limitations to each hot folder in correspondence with each user will be described later using FIGS. 13 to 16.

If the user does not have any authority of color printing, the flow advances to step S1306, and the MIS server 107 issues a monochrome print execution instruction to the monochrome printer 110, thus executing a print process using that printer 110. On the other hand, if the user has the authority of color printing, the flow advances to step S1305, and the MIS server 107 issues a color print execution instruction to the color printer 1101, thus executing a color print process using that printer 1101.

Upon completion of the print process, the flow advances to step S1307 to execute a log saving process. That is, the MIS server 107 saves an access date 602 to the hot folder, user name 603, and job name 604 of the user in the database 108, as shown in FIG. 5 (display example 1 of a user log on a Web browser), and allows to browse that log using the Web browser on the PC 109. Since the MIS server can monitor a plurality of hot folders at the same time, information indicating correspondence between users and hot folders used can be saved as a hot folder name 701, as shown in FIG. 6 (display example 2 of a user log on a Web browser). Since hot folders include those which undergo user management, and those which do not undergo user management, when an access log of hot folders which do not undergo user management is recorded, a user name field 603 is left blank, and the hot folder name is stored in a hot folder name field 701 so that the hot folder that does not undergo user management is recognized at a glance, as shown in FIG. 7 (display example 3 of a user log on a Web browser).

Finally, in step S1309 the MIS server 107 transmits an instruction to the PC 101 so as to display the processing result on the PC 101. The user PC 101 receives that instruction, and makes display according to the processing result on its display screen.

As described above, FIGS. 13 to 16 show a display example of operation windows which are required to register users who can access the hot folders, and to limit available print functions of hot folders for respective users. The setting method executed when the print limitations are set to respective hot holders for respective users will be described below using FIGS. 13 to 16.

On the MIS server 107 side, a hot folder operation window 1001 shown in FIG. 13 is opened. This window includes a hot folder name field 1002 of all hot folders connected to the MIS server 107, an update date field 1003 indicating the update dates of these hot holders, a user verification field 1004 which indicates whether a user verification setting of a hot folder of interest is ON/OFF, and a print limitation setting field 1501 which indicates whether a print limitation setting of the hot holder of interest is ON/OFF.

The hot folder operation window further includes a hot folder add button 1005 and hot folder delete button 1006, which are used to add/delete a hot folder.

Furthermore, when a button 1007 used to set user verification for the selected hot folder is pressed, a user who can access that hot folder can be added/deleted.

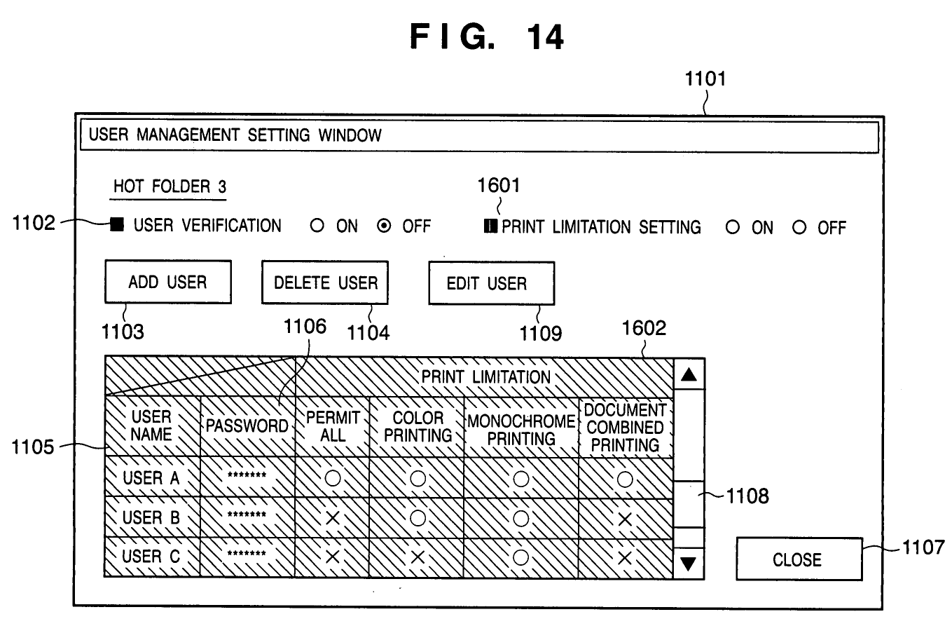

When the user selects an arbitrary hot holder on the hot folder operation window and presses the user management setting button 1007, a user management setting window 1101 shown in FIG. 14 is displayed. This window includes “ON/OFF” check buttons 1102 of “user verification” of the selected hot folder. When the “ON” check button is checked, user verification is required when the user accesses that hot folder.

Furthermore, the user management setting window 1101 displays a user add button 1103, user delete button 1104, and user edit button 1109. When one of these buttons is pressed, a user who can access the hot folder can be added/deleted, or the user name and password can be edited.

The user management setting window includes ON/OFF check buttons or boxes 1601 of “print limitation setting”. This print limitation setting can be set only when user verification is set “ON”. In FIG. 14, since the “OFF” check button 1102 of “user verification” is selected, selection of the check buttons 1601 of “print limitation setting” is disabled. Likewise, since no user verification is made, selection of display items 1105, 1106, and 1602 indicating print limitations is also disabled.

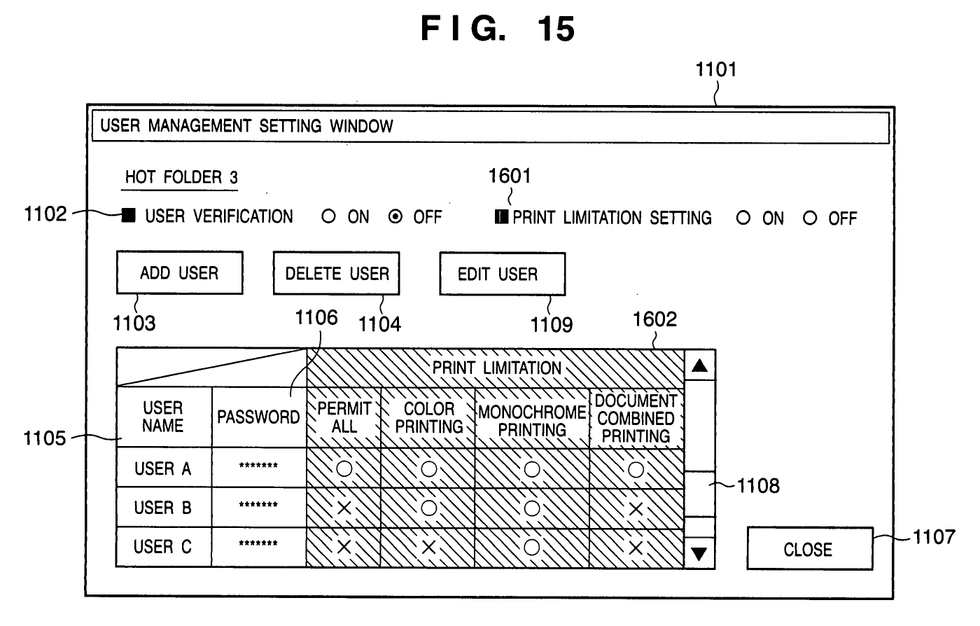

When the “ON” check button 1102 of “user verification” is set, a window shown in FIG. 15 appears, and the display items 1105 and 1106 which show user names and passwords are displayed, thus allowing to add/delete a user and to change the user name and password. At the same time, selection of the ON/OFF check buttons 1601 of “print limitation setting” is enabled.

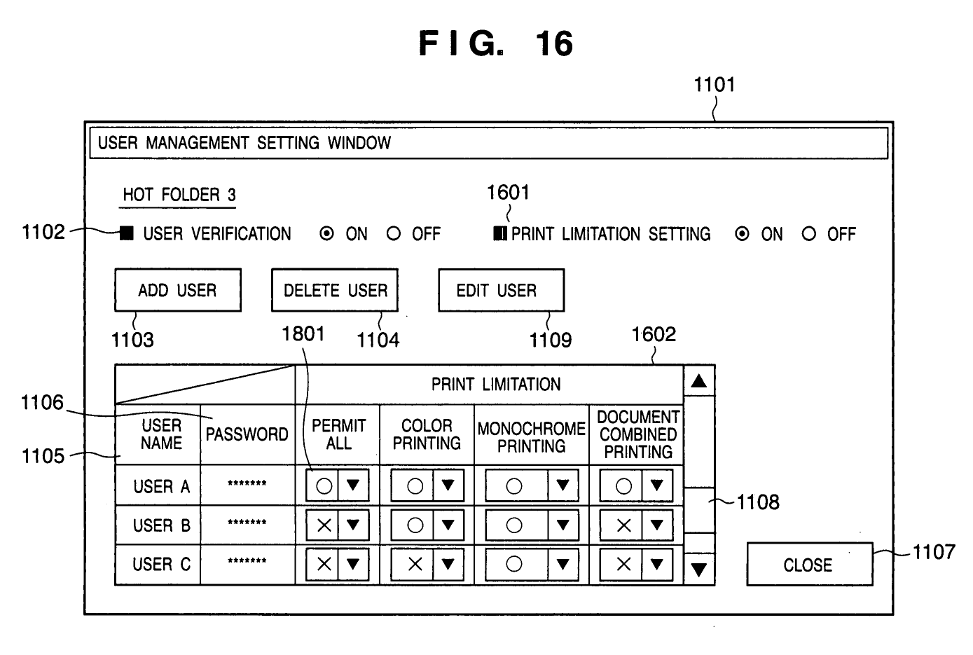

When the “ON” check button 1601 of “print limitation setting” is set on the user management setting window in FIG. 15, a window shown in FIG. 16 appears, and whether the authority of each print limitation item is assigned/not assigned to each user is selected using a corresponding list box 1801.

The print limitation items in FIG. 16 include only those of “color printing”, “monochrome printing”, “document combined printing”, and “permit all”. However, print limitations other than these items can be set.

As described above, according to the second embodiment, since the MIS server 107 can limit users who can access hot folders disclosed on the network, and print settings that can be used by the users, it can be set to allow only a specific user to use an advanced print process (color printing). Hence, flexible security settings can be made for respective users in addition to improvement of the security.

### Third Embodiment

In the first and second embodiments, the hot folders on the network are used, and the MIS server 107 monitors the hot folders on the network to attain user management. However, the third embodiment is characterized in that a hot folder is created in a user PC 101 without any MIS server 107, and a database 1902 which records a user management program and a user access log is arranged in the user PC in order to manage users for that hot holder.

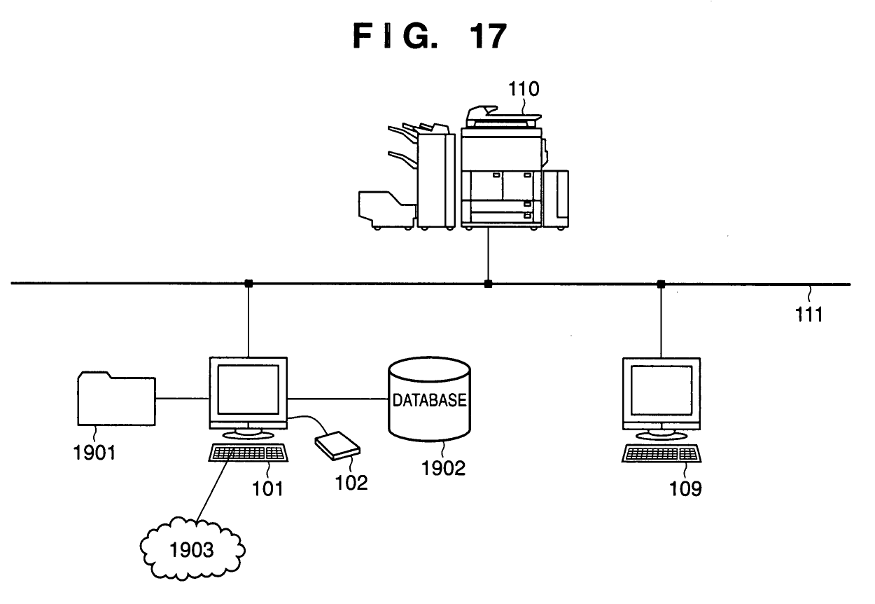

FIG. 17 shows the overall arrangement of the third embodiment. Unlike in the first and second embodiments, no MIS server 107 is required, and a user management program 1903 runs in the user PC instead, thus monitoring users who can access a hot folder on the user PC.

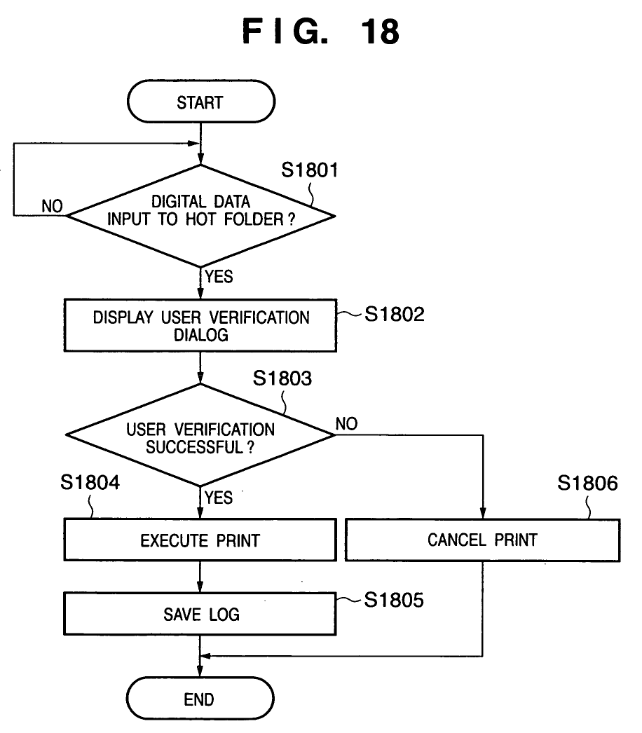

The operation of this embodiment is shown in the flowchart of FIG. 18. However, since the operation of this embodiment is substantially the same as that in FIG. 2 by only replacing the MIS server by the user management program, a description thereof will be omitted.

As described above, according to this embodiment, since the user management program and user management database are arranged in the user PC, user management can be easily applied to a hot folder without equipping any MIS server in an operation environment in which a plurality of users use a single PC.

### Fourth Embodiment

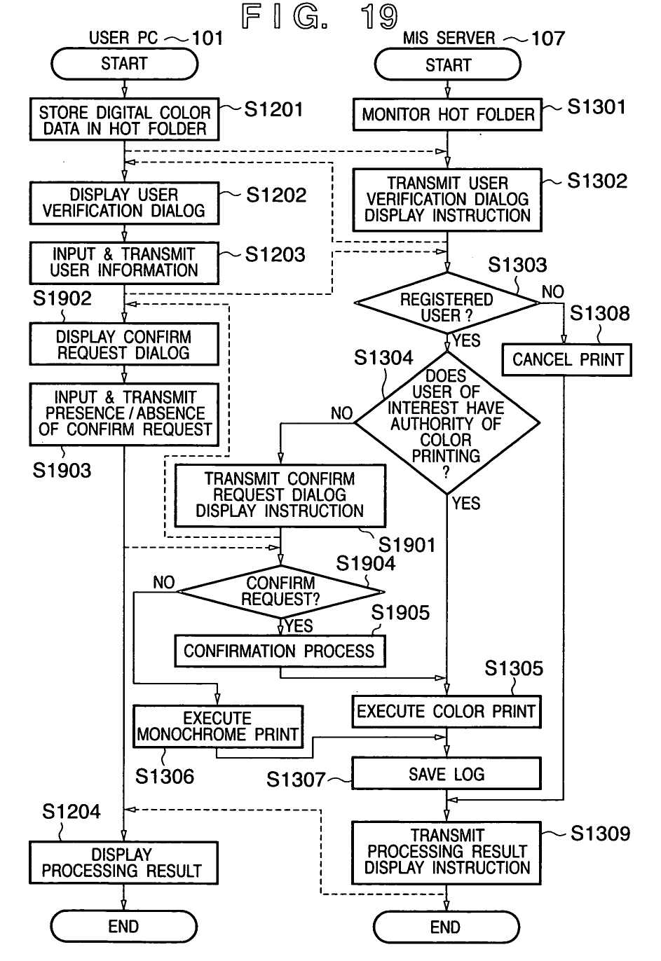

FIG. 19 is a flowchart for explaining the operation of the fourth embodiment. In the fourth embodiment, in addition to the processing of the second embodiment, when the user does not have any authority of color printing, a confirmation process is made. The same step numbers denote steps that execute the same processes as those in the second embodiment, and operations unique to the fourth embodiment will be mainly explained below.

If it is determined in step S1304 that the user does not have any authority of color printing, the flow advances to step S1901. In step S1901, the MIS server 107 transmits an instruction to the user PC 101 to display a dialog to prompt the user to determine whether or not he or she requests to confirm.

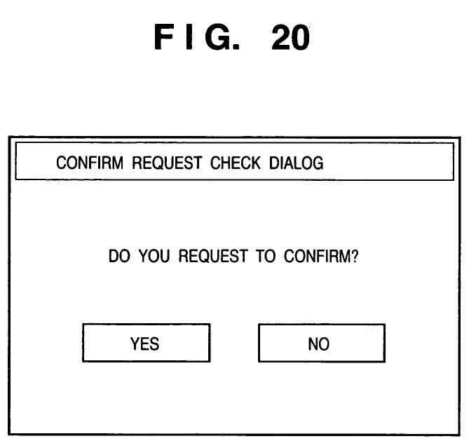

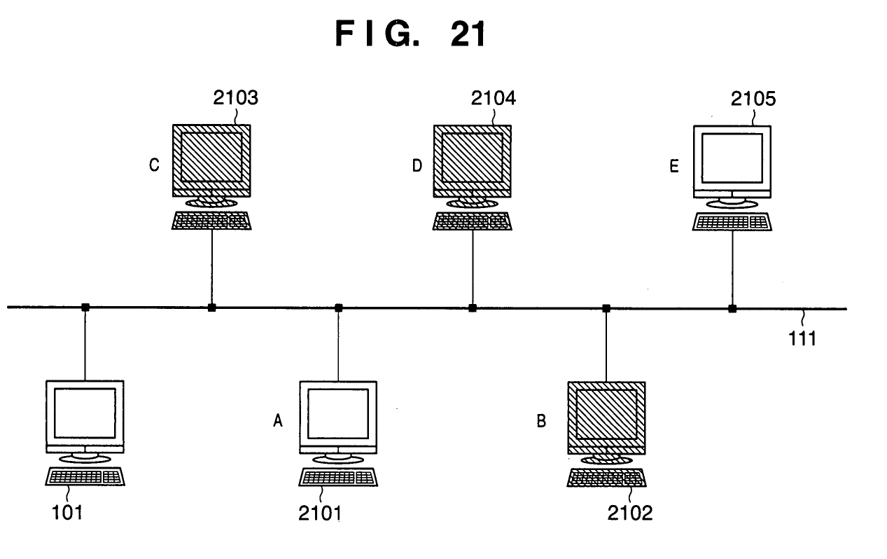

In step S1902, the user PC 101 receives the instruction transmitted from the MIS server 107, and displays a confirmation request dialog on its display screen in response to that instruction. The user inputs the presence/absence of a confirm request, and information about the user to whom the user of the PC 101 requests to confirm. The input information is transmitted to the MIS server 107. Note that FIG. 20 shows an example of a dialog used to input the presence/absence of a confirm request. If the user clicks “YES” in FIG. 20, a window of FIG. 21 is displayed on the screen of the PC 101. FIG. 21 illustrates all or some users connected to the network 111 (FIG. 21 illustrates six users, i.e., the user of the PC 101, and users A to E). Users A and E have authority of color printing, and other users are hatched, i.e., display is made to immediately determine that they have no authority. The user of the PC 101 can select A or E to whom he or she requests to confirm. In this case, the user of the PC 101 can double-click a PC icon of A or E. Upon double-clicking, the presence of a confirm request and information of a confirm request destination are transmitted to the MIS server 107. If the user of the PC 101 does not request to confirm, he or she need only click “NO” in FIG. 20, and that information is transmitted to the MIS server 107.

Next, in step S1904, the MIS server 107 receives information associated with the confirm request from the user PC 101 to determine the presence/absence of the confirm request. If the absence of the confirm request is detected, the flow advances to step S1306 to control the monochrome printer 110 to execute a monochrome print process without any color print process.

On the other hand, if the presence of the confirm request is detected, a confirmation process is executed in step S1905. That is, a process for checking if a confirmer (A or E) designated by the user of the PC 101 permits/denies confirmation. More specifically, the MIS server 107 transmits a confirm form (not shown) to the designated confirmer, and receives a response (confirm OK or NG) to that form. In case of confirm OK, the flow advances to step S1305 to control the color printer 1101 to execute a color print process. In case of confirm NG, permission/denial of confirmation is checked by another confirmer, or a monochrome print process is forcibly executed.

As described above, according to the fourth embodiment, even when a given user does not have any authority of color printing, a path to execute color printing can be assured by executing the confirmation process.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### SUMMARY

According to the embodiment of the present invention, a management server monitors digital data stored in a hot folder, and limits users who can access the hot folder. When the management server detects that print data is input to the hot folder, a user verification dialog is displayed on a computer as a print data input source to make user verification. When the user verification has succeeded, the digital data input to the hot folder is printed using a printer; when the user verification has failed, the print process of the digital data input to the hot folder using the printer is canceled, thereby limiting the user who accesses the hot folder.

Since the management server also has functions of order reception/delivery date management of print jobs, expendable management, and print device management, another server for only user management need not be prepared.

Since the management server can make user management of a plurality of hot folders, only one management server can be used and management is facilitated.

Furthermore, since the user verification can be made using the user name and password or an IC card, the user's operability and security level can be improved.

When the user verification to the hot folder has succeeded, and the print process using the printer is complete, the user name and access date are recorded as a log, thus managing the user who used the hot folder.

Since the recorded log is allowed to be browsed by the administrator using a Web browser, the administrator can easily browse the log of users who used the hot folders using the Web browser.

According to the embodiment of the present invention, there is provided a printing system that prints digital data via a hot folder, and a management server monitors digital data stored in a hot folder, limits users who can access the hot folder, and limits available print functions for respective users. When the management server detects that print data is input to the hot folder, a user verification dialog is displayed on a computer as a print data input source to make user verification. When the user verification has succeeded, a printer is controlled to print the digital data input to the hot folder by limiting print functions set for the user by the print limitation function; when the user verification has failed, the printer is controlled to cancel the print process of the digital data input to the hot folder, thereby limiting the user who accesses the hot folder, and limiting the available functions of the hot holder for respective users.

Since the management server also has functions of order reception/delivery date management of print jobs, expendable management, and print device management, another server for only user management need not be prepared.

Since the management server can make user management of a plurality of hot folders, only one management server can be used and management is facilitated.

The user verification can use the user name and password or an IC card. Especially, the use of the IC card can improve the user's operability and security level.

When the user verification to the hot folder has succeeded, and the print process using the printer is complete, the user name and access date are recorded as a log, thus managing the user who used the hot folder.

Since the recorded log is allowed to be browsed by the administrator using a Web browser, the administrator can easily browse the log of users who used the hot folders using the Web browser.

Moreover, since the print limitation function sets permission/inhibition of a print process with a high value added (e.g., color printing), the available print functions of the hot folder can be flexibly set for respective users.

According to the embodiment of the present invention, there is provided a printing system that prints digital data via a hot folder, and a monitoring program monitors digital data stored in a hot folder on a local computer, and limits users who can access the hot folder. When the monitoring program detects that print data is input to the hot folder, a user verification dialog is displayed on the local computer to make user verification. When the user verification has succeeded, a printer is controlled to print the digital data input to the hot folder; when the user verification has failed, the printer is controlled to cancel the print process of the digital data input to the hot folder, thereby limiting the user who accesses the hot folder only on the local PC without using any server.

Since the monitoring program can make user management of a plurality of hot folders, only one monitoring program to be executed can be launched.

### CLAIM OF PRIORITY

This application claims priority from Japanese Patent Application No. 2004-220684 filed on Jul. 28, 2004, the entire contents of which are hereby incorporated by reference herein.

What is claimed is:

1. A data processing method suited to a printing system which has a management unit that monitors a predetermined folder to which digital data is input via a computer, and controls a printer to execute a print process of the digital data input to the predetermined folder, comprising steps of:
making, when the digital data is input to the predetermined folder, the computer as an input source of the digital data display a user verification dialog; and
controlling a print process of the digital data input to the predetermined folder by the printer on the basis of a result of a user verification process executed via the user verification dialog.

2. The method according to claim 1, wherein in the controlling step, when user verification has succeeded, the printer is controlled to print the digital data input to the predetermined folder, and when user verification has failed, the printer is controlled to cancel the print process of the digital data input to the predetermined folder.

3. The method according to claim 1, wherein the management unit also has functions of order reception/delivery date management of print jobs, expendable management, and print device management.

4. The method according to claim 1, wherein the management unit makes user management of a plurality of predetermined folders.

5. The method according to claim 1, wherein the user verification process uses a user name and password.

6. The method according to claim 1, wherein the user verification process uses an IC card.

7. The method according to claim 1, further comprising a step of recording, when the user verification to the predetermined folder has succeeded and the print process of the printer is complete, a user name and access date as log information.

8. The method according to claim 7, wherein the log information can be browsed using a Web browser.

9. The method according to claim 1, further comprising steps of:
managing information of users who can access the predetermined folder, and limiting available print functions for respective users; and
controlling, when user verification has succeeded in the user verification process, the printer to execute a print process of the digital data input to the predetermined folder by limiting a print function set for the user of interest, and controlling, when user verification has failed in the user verification process, the printer to cancel the print process of the digital data input to the predetermined folder.

10. The method according to claim 9, wherein when the available print functions are limited for respective users, permission/inhibition of a print process with a high value added including a color print function can be set.

11. The method according to claim 1, further comprising steps of:
monitoring digital data stored in the predetermined folder on a local computer;
limiting users who can access the predetermined folder in the local computer;
displaying, when the digital data is input to the predetermined folder, a user verification dialog on the local computer; and
controlling, when user verification has succeeded via the user verification dialog on the local computer, the printer to print the digital data input to the predetermined folder, and controlling, when user verification has failed via the user verification dialog on the local computer, the printer to cancel the print process of the digital data input to the predetermined folder.

12. The method according to claim 1, wherein the predetermined folder includes a common folder on the network, and
said method further comprises steps of:
making, when the digital data is input to the common folder, the computer as an input source of the digital data display a user verification dialog; and
permitting a print process of the digital data input to the common folder by the printer on the basis of a result of a user verification process executed via the user verification dialog.

13. The method according to claim 1, wherein the predetermined folder includes a predetermined folder on a local computer, and
said method further comprises steps of:
making, when the digital data is input to the predetermined folder, the local computer display a user verification dialog; and
permitting a print process of the digital data input to the predetermined folder by the printer on the basis of a result of a user verification process executed via the user verification dialog.

14. A computer-readable storage medium storing a computer algorithm for implementing a data processing method suited to a printing system which has a management unit that monitors a predetermined folder to which digital data is input via a computer, and controls a printer to execute a print process of the digital data input to the predetermined folder,
said computer algorithm comprising:
a program code of making, when the digital data is input to the predetermined folder, the computer as an input source of the digital data display a user verification dialog; and
a program code of controlling a print process of the digital data input to the predetermined folder by the printer on the basis of a result of a user verification process executed via the user verification dialog.

15. A printing system which has a management unit that monitors a predetermined folder to which digital data is input via a computer, and controls a printer to execute a print process of the digital data input to the predetermined folder, comprising:
a display unit for, when the digital data is input to the predetermined folder, making the computer as an input source of the digital data display a user verification dialog; and
a controller for controlling a print process of the digital data input to the predetermined folder by the printer on the basis of a result of a user verification process executed via the user verification dialog.

16. The system according to claim 15, wherein when user verification has succeeded, said controller controls the printer to print the digital data input to the predetermined folder, and when user verification has failed, said controller controls the printer to cancel the print process of the digital data input to the predetermined folder.

17. The system according to claim 15, wherein the management unit also has functions of order reception/delivery date management of print jobs, expendable management, and print device management.

18. The system according to claim 15, wherein the management unit makes user management of a plurality of predetermined folders.

19. The system according to claim 15, wherein the user verification process uses a user name and password.

20. The system according to claim 15, wherein the user verification process uses an IC card.

21. The system according to claim 15, further comprising a recording unit for, when the user verification to the predetermined folder has succeeded and the print process of the printer is complete, recording a user name and access date as log information.

22. The system according to claim 21, wherein the log information can be browsed using a Web browser.

23. The system according to claim 15, further comprising:
a print function limiting unit for limiting available print functions for respective users,
wherein the management unit manages information of users who can access the predetermined folder, and
when user verification has succeeded in the user verification process, said controller controls the printer to execute a print process of the digital data input to the predetermined folder by limiting a print function set for the user of interest, and when user verification has failed in the user verification process, said controller controls the printer to cancel the print process of the digital data input to the predetermined folder.

24. The system according to claim 23, wherein when the available print functions are limited for respective users, permission/inhibition of a print process with a high value added including a color print function can be set.

25. The system according to claim 15, further comprising:
a monitoring unit for monitoring digital data stored in the predetermined folder on a local computer; and
an access limiting unit for limiting users who can access the predetermined folder in the local computer,
wherein when the digital data is input to the predetermined folder, said display unit displays a user verification dialog on the local computer, and
when user verification has succeeded via the user verification dialog on the local computer, said controller controls the printer to print the digital data input to the predetermined folder, and when user verification has failed via the user verification dialog on the local computer, said controller controls the printer to cancel the print process of the digital data input to the predetermined folder.

26. The system according to claim 15, wherein the predetermined folder includes a common folder on the network,
when the digital data is input to the common folder, said display unit makes the computer as an input source of the digital data display a user verification dialog, and
said controller permits a print process of the digital data input to the common folder by the printer on the basis of a result of a user verification process executed via the user verification dialog.

27. The system according to claim 15, wherein the predetermined folder includes a predetermined folder on a local computer,
when the digital data is input to the predetermined folder, said display unit makes the local computer display a user verification dialog, and
said controller permits a print process of the digital data input to the predetermined folder by the printer on the basis of a result of a user verification process executed via the user verification dialog.
